(19) United States
(12) Patent Application Publication
(10) Pub. No.: US 2008/0134664 A1
(43) Pub. Date: Jun. 12, 2008

(54) THRUST REVERSER PIN LOCK

(75) Inventors: JOHN M. BRANNON, WICHITA, KS (US); JOE E. STERNBERGER, WICHITA, KS (US)

Correspondence Address: HOVEY WILLIAMS LLP, 10801 Mastin Blvd., Suite 1000, Overland Park, KS, 66210, US

(73) Assignee: SPIRIT AEROSYSTEMS, INC., WICHITA, KS (US)

(21) Appl. No.: 11/567,407

(22) Filed: Dec. 6, 2006

(51) Int. Cl. F02K 1/76

(52) U.S. Cl. 60/226.2

(57) ABSTRACT

Embodiments of the present invention provide a locking device (20) operable to prevent accidental deployment of a pivot door thrust reverser. The locking device (20) generally comprises a pin lock receiver (32) operable to fixedly couple with a pivot door (18), a housing (34) operable to be coupled with a nacelle (14), and a piston (36) having a pin lock (38). The piston (36) is at least partially positioned within the housing (34) and is operable to be actuated between a locked position and an unlocked position. In the locked position the pin lock (38) is operable to mate with the pin lock receiver (32) and in the unlocked position the pin lock (38) is detached from the pin lock receiver (32) to allow deployment of the pivot door (18). Such a configuration allows pivot door thrust reversers to be locked without requiring the use of heavy and cumbersome parts.

### BACKGROUND OF THE INVENTION

1. Field of the Invention

Embodiments of the present invention relate to devices for preventing the accidental deployment of jet engine thrust reversers. More particularly, various embodiments of the present invention relate to a locking device including a pin lock operable to prevent accidental deployment of a pivot door thrust reverser.

2. Description of the Related Art

Thrust reversers are commonly used to decelerate aircraft after landing by restricting the exhaust gases produced by jet engines. Pivot door thrust reversers are often used for this purpose and generally comprise a door that pivots behind a jet engine to restrict the flow of exhaust gases. Although pivot door thrust reversers effectively slow aircraft, care must be taken to ensure that they are not accidentally deployed during take-off or flight, which may result in disaster.

Locking devices for pivot door thrust reversers have been developed to limit accidental thrust reverser deployment. Unfortunately, these locking devices require the use of numerous complex and heavy parts, including pivoting S-hooks, which increase aircraft weight and cost. Further, such locking devices are not operable to be easily actuated by a technician, thereby inhibiting jet engine maintenance. Thus, locking devices for pivot door thrust reversers suffer from several disadvantages.

### SUMMARY OF THE INVENTION

Embodiments of the present invention solve the above-described problems and provide a distinct advance in the art of thrust reverser locking devices. More particularly, various embodiments of the invention relate to a locking device including a pin lock operable to prevent accidental deployment of a pivot door thrust reverser. Such a configuration allows pivot door thrust reversers to be locked without requiring the use of heavy and cumbersome parts.

In one embodiment, the present invention provides a locking device operable to prevent the deployment of a thrust reverser pivot door from an engine nacelle. The locking device generally comprises a pin lock receiver operable to fixedly couple with the pivot door, a housing operable to be coupled with the nacelle, and a piston having a pin lock positioned at its aft end. The piston is at least partially positioned within the housing and is operable to be actuated between a locked position and an unlocked position. In the locked position the pin lock is operable to mate with the pin lock receiver and in the unlocked position the pin lock is detached from the pin lock receiver to allow deployment of the pivot door.

In another embodiment, the locking device generally comprises a pin lock receiver operable to fixedly couple with the pivot door, a housing operable to be coupled with the nacelle, and a piston having a pin lock positioned on its aft portion. The piston is at least partially positioned within the housing and is operable to be hydraulically actuated between a locked position and an unlocked position only when the pivot door is in an over stowed position. The pin lock operable to mate with the pin lock receiver only when the pivot door is in a stowed position and the piston is in the locked position. The locking device further comprises a spring element positioned within the housing and operable to bias the piston towards the locked position.

In another embodiment, the present invention provides an aircraft engine assembly. The aircraft engine assembly generally includes an engine and fan assembly, a nacelle at least partially enclosing the engine and fan assembly, a pivot door actuator coupled with the nacelle, a pivot door coupled with the pivot door actuator, and a locking device. The pivot door actuator is operable to position the pivot door in stowed, over-stowed, and deployed positions. The locking device generally comprises a pin lock receiver operable to fixedly couple with the pivot door, a housing operable to be coupled with the nacelle, and a piston having a pin lock positioned on its aft portion. The piston is at least partially positioned within the housing is operable to be hydraulically actuated between a locked position and an unlocked position only when the pivot door is in the over-stowed position. The pin lock is operable to mate with the pin lock receiver only when the pivot door is in the stowed position and the piston is in the locked position.

Other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is top sectional view of an aircraft engine assembly including a pivot door thrust reverser, the pivot door shown in a stowed position;

FIG. 2 is a partial cross sectional view of the aircraft assembly of FIG. 1, showing the pivot door in more detail;

FIG. 3 is a partial cross sectional view of the aircraft assembly of FIGS. 1-2, showing the pivot door in a deployed position;

FIG. 4 is a partial cross sectional view of an aircraft engine assembly including a thrust reverser locking device configured in accordance with various preferred embodiments of the present invention;

FIG. 5 is a partial cross sectional view of the locking device of FIG. 4, the locking device shown including a piston positioned in a locked position;

FIG. 6 is a partial cross sectional view of the locking device of FIGS. 4-5, the piston shown detaching from a pin lock receiver;

FIG. 7 is a partial cross sectional view of the locking device of FIGS. 4-6, the piston shown in an unlocked position;

FIG. 8 is a partial cross sectional view of the locking device of FIGS. 4-8, the locking device shown coupled with a manual retraction handle; and

FIG. 9 is a partial cross sectional view of a locking device configured in accordance with various alternative preferred embodiments of the present invention.

The drawing figures do not limit the present invention to the specific embodiments disclosed and described herein. The drawings are not necessarily to scale, emphasis instead being placed upon clearly illustrating the principles of various embodiments of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

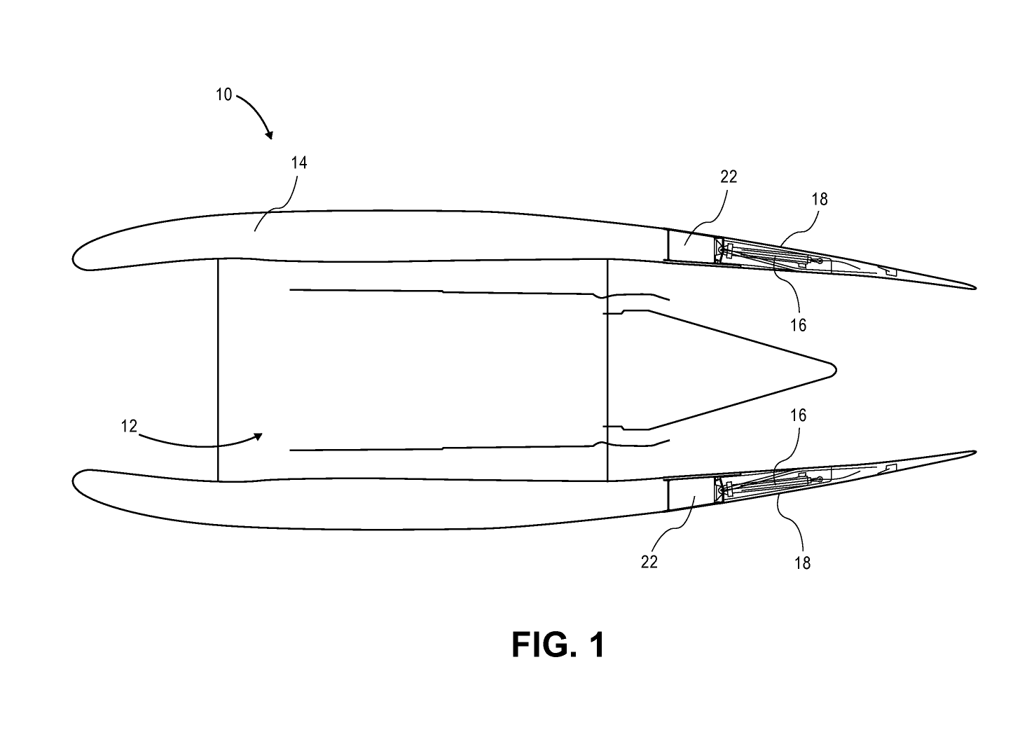

Turning now to the drawing figures, and particularly FIGS. 1-8, an aircraft engine assembly 10 constructed in accordance with various preferred embodiments of the present invention is illustrated. The aircraft engine assembly 10 is configured for attachment to an aircraft and broadly includes an engine and fan assembly 12, a nacelle 14 for supporting and partially enclosing the engine and fan assembly 12, a pivot door actuator 16 and pivot door 18 for reversing thrust produced by the engine and fan assembly 12, and a locking device 20 operable to prevent accidental deployment of the pivot door 18.

The engine and fan assembly 12 is conventional and includes an engine and a fan coupled for rotation to the engine. The engine is preferably a jet engine, such as a gas turbine engine, but it may be any other conventional type of engine. The fan is also conventional and includes a plurality of circumferentially spaced fan blades. As viewed from the perspective of FIG. 1, air utilized by the engine and fan assembly 12 to produce thrust enters from the left, is compressed by the fan blades, and is forced out vents or ducts on the right of the engine and fan assembly 12 to produce thrust in a conventional manner.

The nacelle 14 supports and partially encloses the engine and fan assembly 12 in a generally conventional manner. The nacelle 14 may be formed of any suitable material such as aluminum, steel, fiberglass or other conventional metal or composite material. The nacelle 14 is spaced outwardly from the engine and fan assembly 12 to facilitate the flow of air through the engine and fan assembly 12 and the development of thrust.

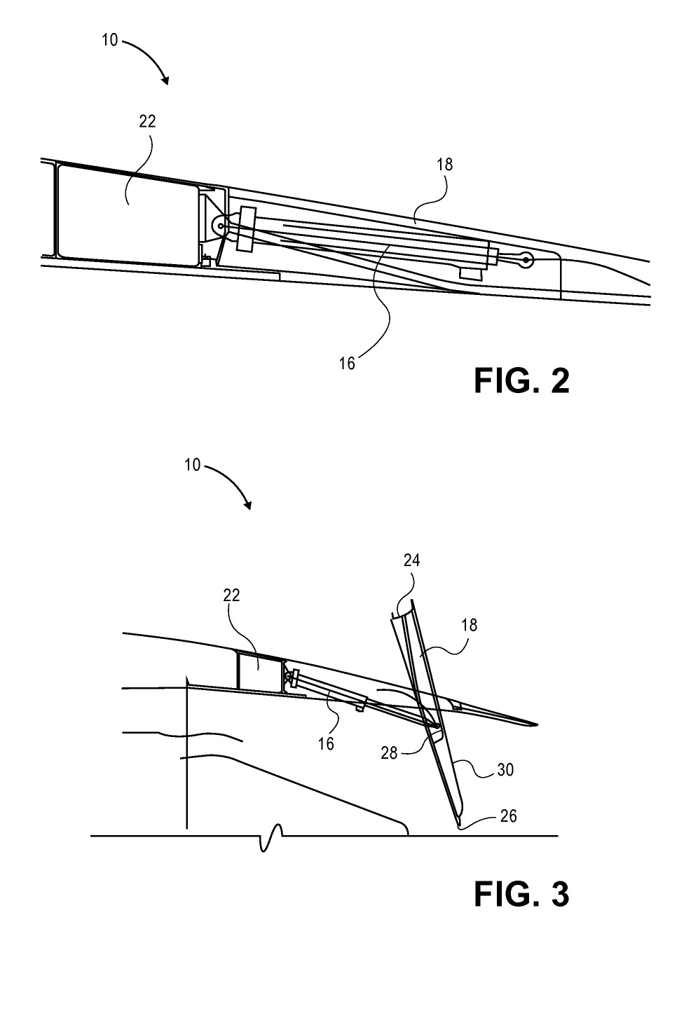

The pivot door actuator 16 is coupled with the nacelle 14 and the pivot door 18 to enable the pivot door 18 to pivot at least partially behind the engine and fan assembly 12 to reverse at least a portion of produced thrust, as shown in FIGS. 2-3. The pivot door actuator 16 and pivot door 18 may be generally conventional and provide generally conventional pivot door thrust reverser functionality.

The pivot door actuator 16 is preferably coupled with the nacelle 14. For instance, the nacelle 14 may include a fixed structure portion 22 for safely and securely coupling with pivot door actuator 16. The pivot door actuator 16 may be substantially conventional and include telescoping, extending, pivoting, and rotating elements and components.

The pivot door 18 is conventionally coupled with the pivot door actuator 16 such that the pivot door 18 may be positioned to at least partially reverse thrust provided by the engine and fan assembly 12. The pivot door 18 generally comprises a forward portion 24, an aft portion 26, an inner side 28, and an outer side 30. The pivot door actuator 16 is preferably coupled with a portion of the inner side 28 to facilitate deployment of the pivot door 18 as discussed in more detail below.

Preferably, the pivot door actuator 16 is operable to position the pivot door 18 in stowed, over-stowed, and deployed positions. As shown in FIGS. 2, and 4-5, the pivot door 18 is positioned in the stowed position during normal operation conditions—i.e. conditions in which the reversal of thrust is not desirable. Thus, in the stowed position the pivot door 18 is substantially retained within or adjacent to the nacelle 14 as shown in FIG. 2.

In the over-stowed position, shown in FIG. 6, the pivot door actuator 16 positions the pivot door 18 such that its forward portion 24 is moved downward relative to the locking device 20. Thus, the over-stowed position may correspond to any position in which the forward portion 24 of the pivot door 18 is moved at least partially downward relative to the locking device 20. As is discussed in more detail below, positioning of the pivot door 18 in the over-stowed positioned allows the locking device 20 to be actuated between locked and unlocked positions.

In the deployed position, shown in FIG. 3, the pivot door actuator 16 positions the pivot door 18 such that its inner side 28 restricts at least a portion of the exhaust gases produced by the engine and fan assembly 12. The positioning of the pivot door 18 in the deployed position and the thrust reversal provided by the deployed pivot door 18 is substantially conventional.

As should be appreciated by those skilled in the art, the pivot door actuator 16 is operable to position the pivot door 18 in a plurality of intermediate positions between the stowed, over-stowed, and deployed positions. FIG. 7 illustrates one of the intermediate pivot door positions between the over-stowed and deployed positions.

The locking device 20 is operable to prevent accidental deployment of the pivot door 18 such as inadvertent movement of the pivot door 18 from the stowed position to the deployed position. The locking device 20 broadly comprises a pin lock receiver 32 operable to fixedly couple with the pivot door 18, a housing 34 operable to be coupled with the nacelle 14, and a piston 36 at least partially positioned within the housing 34 and operable to be actuated between locked and unlocked positions to control deployment of the pivot door 18. Various embodiments of piston 36 include a pin lock 38 operable to mate with the pin lock receiver 32 to lock the pivot door 18.

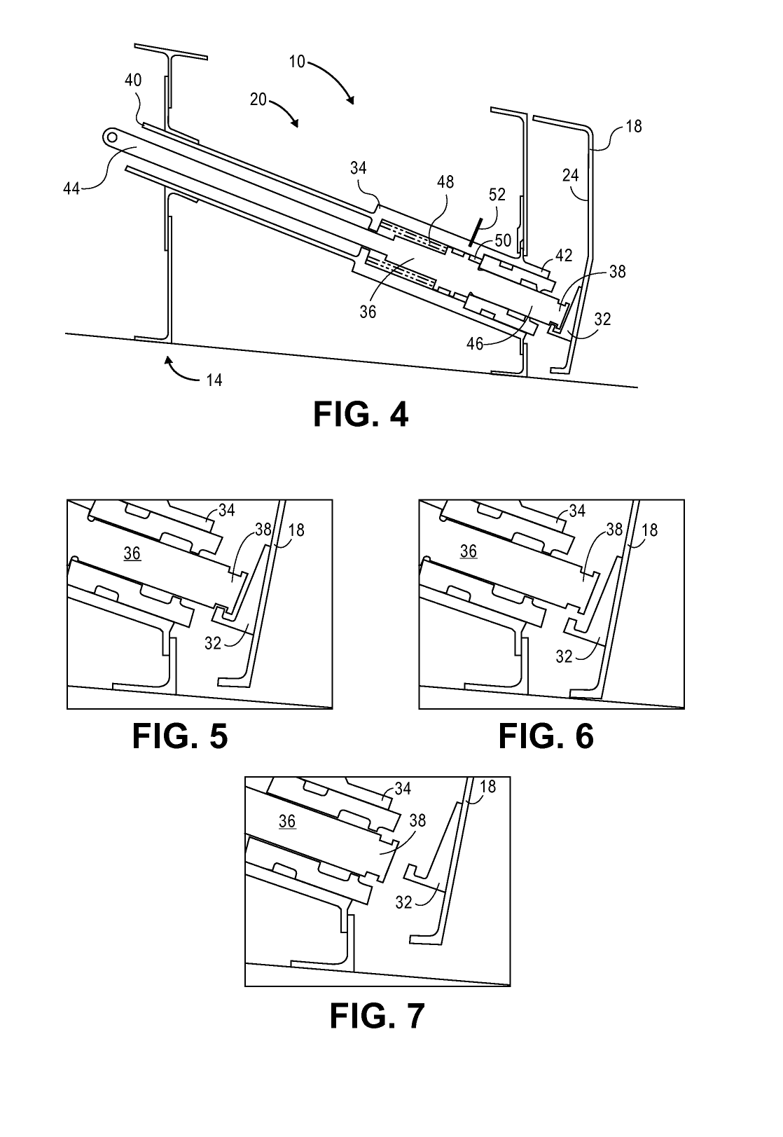

The pin lock receiver 32 is fixedly coupled with the pivot door 18 and is operable to mate with at least a portion of the piston 36—preferably the pin lock 38—to prevent deployment of the pivot door 18. The pin lock receiver 32 is preferably fixedly coupled with the forward portion 24 of the pivot door 18 as shown in FIGS. 4-8. In some embodiments, the pin lock receiver 32 may be integral with the forward portion 24 or screwed, bolted, or welded thereto.

As shown in FIGS. 5-7, the pin lock receiver 32 is preferably substantially L-shaped such that it includes an elongated rear portion for fixedly coupling with the pivot door 18 and a mating portion spaced away from the rear portion for interlocking with the pin lock 38. Utilization of an L-shape is desirable as the elongated rear portion provides a contact area to receive the piston 36 when the pivot door 18 is in the over-stowed position and the piston 36 is actuated to the locked position. Such a configuration enables the elongated rear portion to provide a guide for the mating portion as the pivot door 18 is moved to the stowed position and locked. However, as should be appreciated, the pin lock receiver 32 may present any shape or configuration for mating with the piston 36.

The housing 34 is coupled with the nacelle 14 and positioned such that the piston 36 may be actuated at least partially within the housing 34 to contact the pin lock receiver 32 when the pivot door 18 is in the stowed position. The housing 34 is preferably fixedly coupled to at least one of the bulkheads that form the nacelle 14, and preferably coupled with at least two bulkheads at opposite ends of the housing 34, to prevent movement of the housing 34.

The housing 34 generally includes a forward end 40 and an aft end 42. Preferably, the forward end 40 is positioned slightly above the aft end 42 to bias, by gravity, the piston 36 towards the locked position. Both ends 40, 42 are preferably at least partially open such that the housing 34 presents a generally tubular configuration. However, as should be appreciated, the housing 34 may present any configuration operable to retain various portions of the locking device 20 and allow actuation of the piston 36.

The piston 36 is at least partially positioned within the housing 34 and is operable to be actuated between locked and unlocked positions to control deployment of the pivot door 18. In the locked position, the piston 36 is substantially extended from the housing 34 and operable to contact the pin lock receiver 32. In the unlocked position, the piston 36 is substantially retracted within the housing 34 and not operable to contact the pin lock receiver 32 or other portions of the pivot door 18.

The piston 36 includes a forward portion 44 and an aft portion 46, where the forward portion 44 is positioned generally away from the pivot door 18 and the aft portion 46 is positioned generally towards the pivot door 18. Preferably, the piston 36 is actuated such that the aft portion 46 moves as least partially in and out of the housing 34 to contact at least a portion of the pivot door 18 or pin lock receiver 32. As the piston 36 is preferably coaxially retained within the housing 34, actuation of the piston 36 more preferably causes the piston to move generally parallel to both its longitudinal axis and the longitudinal axis of the housing 34.

The aft portion 46 is operable to mate with the pin lock receiver 32 to securely the couple the locking device 20 to the pivot door 18. For instance, in the locked position, the piston 36, and preferably its aft portion 46, couples with the pin lock receiver 32 to prevent deployment of the pivot door 18—i.e. movement of the pivot door from the stowed position to the deployed position. Thus, when in the locked position, the piston 36 only allows the pivot door 18 to be actuated from the stowed position to the over-stowed position.

Preferably, the aft portion 46 of the piston 36 includes the pin lock 38 to interlock with the pin lock receiver 32. As shown in FIGS. 4-7, the pin lock 38 is positioned such that it may interlock with the pin lock receiver 32 to prevent undesired movement of the pivot door 18. The pin lock 38 preferably comprises a recess formed on the aft portion 46 of the piston 36 to enable interlocking reception of the mating portion of the pin lock receiver 32. Utilization of this pin lock 38 configuration is desirable as it enables the pivot door 18 to move from the stowed positioned to the over-stowed position, as discussed in more detail below, while preventing the pivot door 18 from moving significantly in other directions, such as from the stowed position to the deployed position. However, the pin lock 38 and pin lock receiver 32 may comprise any interlocking or mating pair operable to allow movement of the pivot door 18 from the stowed position to the over-stowed position while restricting other pivot door 18 movement.

In various embodiments the locking device 20 further includes a spring element 48 operable to bias the piston 36 towards the locked position. Such biasing is desirable as it restricts accidental movement of the piston 36 from the locked position to the unlocked position—and thus accidental deployment of the pivot door 18. Preferably, the spring element 48 is positioned forward of the aft portion 46 of the piston 36 within the housing 34 to bias the piston 36 towards the locked position—e.g. the position where the piston 36 is substantially extended from the housing 34 and operable for mating with the pin lock receiver 32.

The spring element 48 may comprise conventional springs or other resistive elements to provide the desired biasing force. In some embodiments, the spring element 48 may comprise a plurality of springs positioned around the periphery of the piston 36 to uniformly apply the biasing force and also allow desired redundancy in the event of the failure of any one of the springs.

In various preferred embodiments, the piston 36 is hydraulically actuated between the locked and unlocked positions. In such embodiments, the housing 34 includes a hydraulic supply cavity 50 operable to receive fluid from a hydraulic supply 52 to actuate the piston 36 from the locked position to unlocked position. The hydraulic supply cavity 50 is formed within the housing 34 between the piston 36 and the walls of the housing 34 such that fluid pressure is applied to the piston 36 with the hydraulic supply cavity 50 is filled to force the piston 36 to the unlocked position. In embodiments where a biasing force is applied by the spring element 48 and/or gravity to bias the piston 36 towards the locked position, the applied fluid pressure at least partially overcomes the biasing force to move the piston 36 towards the locked position.

As should be appreciated by those skilled in the art, the hydraulic supply 52 may be conventionally controlled to provide a desired amount of fluid and/or fluid pressure to actuate the piston 36. The hydraulic supply cavity 50 may include conventional gaskets and other elements to facilitate hydraulic and efficient actuation of the piston 36. Further, various embodiments of the present invention may include more than one hydraulic supply cavity and hydraulic supply to enable the piston 36 to be hydraulically actuated in more than one direction.

Additionally, the locking device 20 may include other actuation elements instead of or in addition to the hydraulic elements discussed above. For instance, the locking device 20 may include conventional actuation elements such as motors and solenoids to actuate the piston 36 in desired directions.

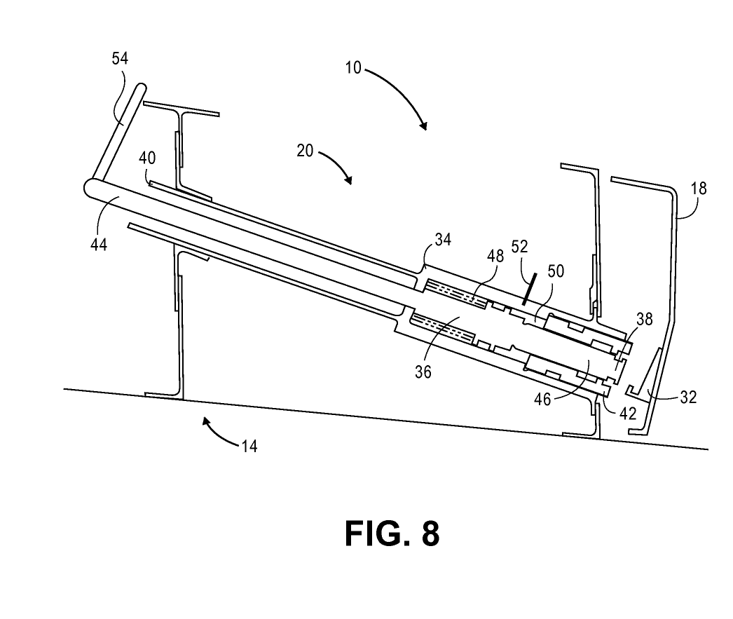

In some embodiments, the locking device 20 may include or be operable for coupling with a manual retraction handle 54. The handle 54 extends from the housing 34 and is coupled with the piston 36 to enable manual action of the piston 36. In particular, the handle 54 may by used to manually actuate the piston between the locked and unlocked positions. In embodiments were biasing forces are applied to the piston 36, the handle 54 allows manual forces to be applied to overcome the biasing forces and actuate the piston from the locked position to the unlocked position. The handle 54 is preferably coupled with the forward portion 44 of the piston 36 to limit the length of the handle 54 and to enable the handle 54 to desirably extend out of the nacelle 14 forward of the forward bulkhead, as is shown in FIG. 8.

In embodiments where the handle 54 is employed, the housing 34 and/or nacelle 14 preferably provide a detent for retention of the handle 54. As is discussed in more detail below, the detent allows the handle 54 to be actuated and retained within the detent to hold the piston 36 in the unlocked position. The position and configuration of the detent will depend on the size of the handle 54 and the amount the handle 54 must be manipulated to move the piston 36 from the locked to unlocked position.

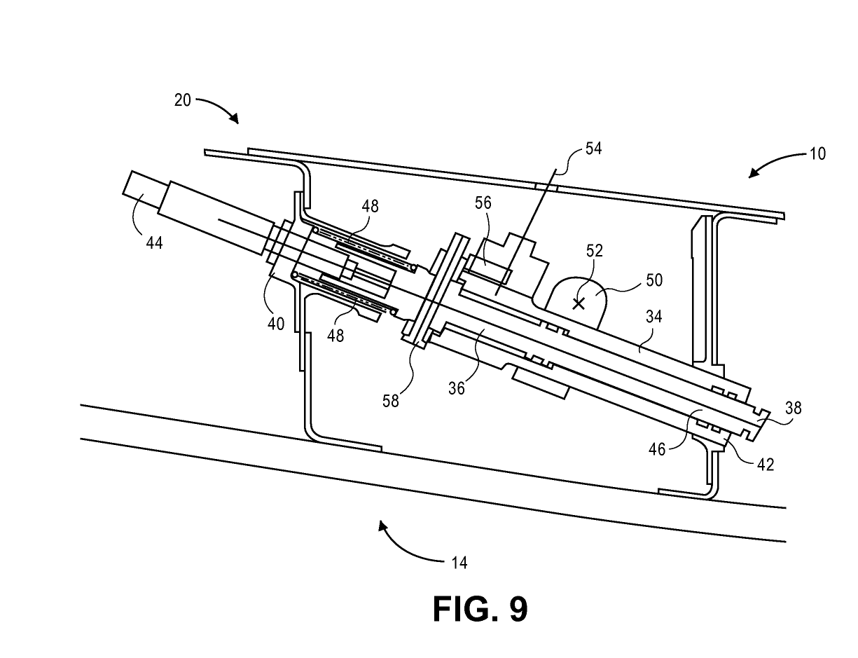

In some embodiments, such as the embodiments illustrated in FIG. 9, the manual retraction handle 54 may be coupled with a manual release cam 56. The manual release cam 56 is functionally coupled with a cam roller 58 to facilitate manual actuation of the piston 36. In particular, the handle 54 may be manipulated to function the cam 56 to allow manual actuation of the piston 36 between the locked and unlocked positions.

The locking device 20 may be used in both primary and tertiary locking applications. For instance, conventional locking devices may be employed as the primary pivot door locking mechanism and the locking device 20 may used for secondary, tertiary, or other backup locking applications. Similarly, the locking device 20 may be used for primary pivot door locking and S-hooks and other conventional locking elements may be used for backup locking applications.

Although a single pivot door 18, pivot door actuator 16, and locking device 20 are discussed above, various embodiments of the present invention may employ any number of pivot doors 18, pivot door actuators 16, and locking devices 20. For instance, aircraft engine assemblies often have a pair of pivot doors positioned on opposing sides of the nacelle, as shown in FIG. 1. In embodiments where a plurality of pivot doors 18 are utilized, a pivot door actuator 16 and locking device 20 are preferably utilized for each pivot door 18.

In operation, the aircraft engine assembly 10 is configured as described above. In typical operation of the aircraft to which the aircraft engine assembly 10 is attached, the pivot door 18 will be in the stowed position and the piston 36 will be in the locked position, as shown in FIG. 4. In such a configuration, the thrust produced by the engine and fan assembly 12 is not restricted by the pivot door 18 and the piston 36 is coupled with the pin lock receiver 32 to prevent undesired movement of the pivot door 18. For example, the pin lock 38 is securely received by the pin lock receiver 32 such that the pivot door 18 may not move from the stowed position to the deployed position. As discussed above, a biasing force is preferably provided by the orientation of the housing 34 and the spring element 48 to ensure that the piston 36 and pin lock receiver 32 remain mated.

When it is desired to deploy the pivot door 18 and reverse the thrust provided by the engine and fan assembly 12, the pivot door actuator 16 is functioned to move the pivot door 18 from the stowed position to the over-stowed position, as shown in FIG. 6. The configuration of the piston 36 and the pin lock receiver 32, and in particular the pin lock 38 and the pin lock receiver 32, allows the pivot door actuator 16 to move the pivot door 18 to the over-stowed position without requiring movement of the piston 36. Thus, the piston 36 preferably remains in the locked position while the pivot door 18 moves from the stowed to the over-stowed position to facilitate uncoupling of the pin lock 38 and pin lock receiver 32.

After the pivot door 18 is moved to the over-stowed position, the piston 36 is actuated from the locked position to the unlocked position. As discussed above, the piston 36 may be manually actuated using the handle 54, the piston 36 may be hydraulically actuated, and/or the piston 36 may be actuated using conventional elements such as solenoids or motors. In the locked position, the piston at least partially retracts into the housing 34, as shown in FIG. 7, to allow the pivot door 18 to move from the over-stowed to the deployed position upon actuation by the pivot door actuator 16. The pivot door 18 is shown the fully deployed position in FIG. 2. Once the pivot door 18 is actuated away from the housing 34 for deployment, the piston 36 may be returned the locked position and/or the piston 36 may be maintained in the locked position until it is desirable to stow the pivot door 18.

To return the pivot door 18 to the stowed position for normal operation of the aircraft engine assembly 10, the process discussed above is generally reversed. In particular, the pivot door actuator 16 moves the pivot door 18 from the stowed position to the over-stowed position. Once the pivot door 18 is in the over-stowed position, the piston 36 is positioned in the locked position. The piston 36 may be actuated to the locked position by applying force, using hydraulics or other elements for example, or may be allowed to return to the locked position by the biasing force. For instance, in embodiments where the piston 36 is hydraulically actuated to the unlocked position, fluid pressure or volume may be reduced to allow the piston 36 to return to the locked position. Thus, it is not necessary to apply an affirmative force to actuate the piston 36 from the unlocked position to the locked position. However, in some embodiments it may be desirable to affirmatively force the piston 36 from the unlocked to the locked position to ensure that it fully extends for coupling with the pin lock receiver 32.

Preferably, return of the piston 36 to the locked position when the pivot door 18 is in the over-stowed position causes the piston 36 to desirably contact the pin lock receiver 32. In embodiments where the pin lock receiver 32 is substantially L-shaped, the piston 36 preferably contacts the elongated rear portion to guide the pin lock 38 into the pin lock receiver 32 as discussed below.

Once the pivot door 18 is in the stowed position and the piston 36 is in the locked position, the pivot door actuator 16 moves the pivot door 18 from the over-stowed position to the stowed position. Movement of the pivot door 18 to the stowed position when the piston 36 is in the locked position causes the piston 36 and the pin lock receiver 32, and in particular the pin lock 38 and the pin lock receiver 32, to interlock as discussed above—thereby securing the pivot door 18 in the stowed position. In embodiments where the pin lock receiver 32 is L-shaped, the elongated rear portion helps guide the mating portion and the pin lock 38 into an interlocking relationship.

By using the handle 54, a user may also perform the above steps manually to easily access the pivot door 18 and other aircraft engine assembly components for maintenance or other purposes. Specifically, the user may couple the handle 54 with the piston 36 and pull or rotate the handle 54 to move the piston 36 from the locked position to the unlocked position. In embodiments where the housing 34 includes a detent for retaining the handle, the piston 36 is advantageously retained in the unlocked position to allow the pivot door 18 to be freely opened and closed. To return the piston 36 to the locked position for normal use, the handle 54 is rotate or pushed out of the detent to allow the piston 36 to engage the pin lock receiver 32. In embodiments including the cam 56, the user may function the handle 54 to actuate the cam 56 to actuate the piston 36 between the locked and unlocked positions.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A locking device operable to prevent the deployment of a thrust reverser pivot door from an engine nacelle, the locking device comprising:
a pin lock receiver operable to fixedly couple with the pivot door;
a housing operable to be coupled with the nacelle; and
a piston having a pin lock, the piston being at least partially positioned within the housing and operable to be actuated between a locked position and an unlocked position, wherein in the locked position the pin lock is operable to mate with the pin lock receiver and in the unlocked position the pin lock is detached from the pin lock receiver.

2. The locking device of claim 1, further including a spring element operable to bias the piston towards the locked position.

3. The locking device of claim 1, wherein the piston is operable to be hydraulically actuated from the locked position to the unlocked position.

4. The locking device of claim 3, wherein the housing includes a hydraulic supply cavity operable to receive hydraulic fluid to actuate the piston from the locked position to the unlocked position.

5. The locking device of claim 1, further including a manual retraction handle extending from the housing and coupled with the piston, the manual retraction handle operable to be used to manually actuate the piston from the locked position to the unlocked position.

6. The locking device of claim 1, wherein the pin lock receiver presents a generally L-shaped configuration.

7. The locking device of claim 1, wherein the piston is operable to be actuated between the locked and unlocked positions only when the pivot door is in an over-stowed position.

8. The locking device of claim 7, wherein the pin lock is operable to mate with the pin lock receiver only when the pivot door is in a stowed position and the piston is in the locked position.

9. A locking device operable to prevent the deployment of a thrust reverser pivot door from an engine nacelle, the locking device comprising:
a pin lock receiver operable to fixedly couple with the pivot door;
a housing operable to be coupled with the nacelle;
a piston having a pin lock positioned on its aft portion, the piston being at least partially positioned within the housing and operable to be hydraulically actuated between a locked position and an unlocked position only when the pivot door is in an over-stowed position, the pin lock operable to mate with the pin lock receiver only when the pivot door is in a stowed position and the piston is in the locked position; and
a spring element positioned within the housing and operable to bias the piston towards the locked position.

10. The locking device of claim 9, wherein the housing includes a hydraulic supply cavity operable to receive hydraulic fluid to actuate the piston from the locked position to the unlocked position.

11. The locking device of claim 9, further including a manual retraction handle extending from the housing and coupled with the piston, the manual retraction handle operable to be used to manually actuate the piston from the locked position to the unlocked position.

12. The locking device of claim 9, wherein the pin lock receiver presents a generally L-shaped configuration.

13. An aircraft engine assembly comprising:
an engine and fan assembly;
a nacelle at least partially enclosing the engine and fan assembly;
a pivot door actuator coupled with the nacelle;
a pivot door coupled with the pivot door actuator, the pivot door actuator operable to position the pivot door in stowed, over-stowed, and deployed positions; and
a locking device including—
a pin lock receiver fixedly coupled with the pivot door,
a housing coupled with the nacelle,
a piston having a pin lock positioned on its aft portion, the piston being at least partially positioned within the housing and operable to be hydraulically actuated between a locked position and an unlocked position only when the pivot door is in the over-stowed position, the pin lock operable to mate with the pin lock receiver only when the pivot door is in the stowed position and the piston is in the locked position, and
a spring element positioned within the housing and operable to bias the piston towards the locked position.

14. The aircraft engine assembly of claim 13, wherein the housing includes a hydraulic supply cavity operable to receive hydraulic fluid to actuate the piston from the locked position to the unlocked position.

15. The aircraft engine assembly of claim 13, further including a manual retraction handle extending from the housing and coupled with the piston, the manual retraction handle operable to be used to manually actuate the piston from the locked position to the unlocked position.

16. The aircraft engine assembly of claim 13, wherein the pin lock receiver presents a generally L-shaped configuration.
